(19) United States
(12) Patent Application Publication
(10) Pub. No.: US 2015/0235532 A1
(43) Pub. Date: Aug. 20, 2015

(54) TABLET STAND APPARATUS, SYSTEM AND METHOD

(71) Applicant: Sennco Solutions, Inc., Plainfield, IL (US)

(72) Inventors: Christopher Marszalek, Plainfield, IL (US); Stephanie Anderson, Naperville, IL (US)

(73) Assignee: Sennco Solutions, Inc., Plainfield, IL (US)

(21) Appl. No.: 14/182,880

(22) Filed: Feb. 18, 2014

(51) Int. Cl. G08B 13/14; G06F 1/16; H02J 7/00; F16M 11/24

(52) U.S. Cl. CPC G08B 13/1409; F16M 11/24; G06F 1/1635; G06F 1/1613; G08B 13/1445; H02J 7/0044

(57) ABSTRACT

A stand apparatus, a system and a method have a post connected to a base and a housing connected to the post. A handheld computer device, such as a tablet, is tethered to the housing. An alarm is activated by disconnecting the tablet from the housing. A sensor cable is connected to the tablet and the housing. A power cord powers the alarm and provides power via the sensor cable for charging and/or for recharging the tablet.

### BACKGROUND OF THE INVENTION

The present invention generally relates to a tablet stand. More specifically, the present invention relates to a portable tablet stand apparatus, a system and a method to allow users access to an electronic tablet.

Computers are provided in numerous types, for example, desktops, laptops, notebooks, tablets and/or the like. Computers are provided in many sizes. Handheld computer devices have become quite popular with users. The handheld computer devices have many benefits. For example, such devices are convenient and/or portable. Generally, handheld computer devices operate using wireless technology. As a result, handheld computer devices typically do not require a wired connection except for charging and/or for recharging an internal battery. Handheld computer devices may be used virtually anywhere and/or at any time since a wired connection is not required.

One type of handheld computer device is generally referred to as a tablet. Tablets are made by a number of manufacturers in different sizes and/or with different features. For example, tablets typically have operating systems which use a wireless local area network connection, an Institute of Electrical and Electronics Engineers' (IEEE) 802.11 compliant connection, a Wi-Fi™ (a registered trademark of the Wi-Fi Alliance) connection, and/or an internet connection. A user may download applications and/or programs to be used on the tablet. In addition, the tablet may also be used to access personal accounts for checking email and/or for participating in social media, for example.

Although tablets are portable, a user may not wish to carry their own tablet at all times. For example, a user may not want to take his or her tablet to an appointment at an office. Often, a waiting area is provided in the office that may have some items to help pass the time. For example, the waiting area may have magazines and/or books to peruse. However, the magazines may be outdated and/or unappealing to some users. Also, some waiting rooms may have a television. However, the television may be fixed on a channel that may not interest all of the people in the waiting area. Further, the television may not be located in a position for all to watch. Since waiting times can be long, the person waiting may become tired, fatigued and/or irritated during an extended wait.

As a result, the owners of an office may want to offer alternatives for occupying time during a impact of a wait for patients and/or customers in the waiting area. For example, the owners may offer a tablet for use in the waiting area. Users may check their email and/or other accounts, play games, surf the internet and/or participate in social media and/or networking. However, the security of the tablets and/or removal of the tablets from the waiting area may be a problem. Therefore, providing theft prevention and/or an alarm to prevent the tablets from being removed from the waiting area is necessary.

A need, therefore, exists for a tablet stand apparatus, a system and/or a method for attaching a tablet. Further, a need exists for a tablet stand apparatus, a system and/or a method that prevents removal and/or theft of the tablet.

### SUMMARY OF THE INVENTION

The present invention generally relates to a tablet stand. More specifically, the present invention relates to a portable tablet stand apparatus, a system and/or a method to allow users access to an electronic tablet for use.

To this end, in an embodiment of the present invention, a tablet stand apparatus is provided. The apparatus may have a base and a post extending from a first end to a second end defining a height of the post. The first end of the post may be attached to the base. The height of the post may be at least twenty-four inches. A housing may connect to the second end of the post. The housing may have a slot configured to receive an electronic device to connect the electronic device to the housing. A sensor cable may connect to the electronic device and to the housing. An alarm may be activated upon disconnection of the sensor cable.

In an embodiment, the housing is translucent.

In an embodiment,a mounting plate may be connected to a sub-plate. The sub-plate may be connected to the post. The mounting plate may be located in a position between the sub-plate and the housing.

In an embodiment, a power cord may extend through an interior of the post.

In an embodiment, a hook attached to the electronic device may engage the slot in the housing to connect the electronic device to the housing.

In another embodiment, a system for electrically connecting and securing a device to a stand is provided. The system may have a post having top and a bottom defining a height of the post. The bottom of the post may connect to a base. The post may extend in a substantially vertical direction from the base. The height of the post is at least twenty inches. A housing may be connected adjacent to the top of the post, and the device may connect to the housing. An alarm associated with the housing may be activated by disconnecting the device from the housing. A power cord may be connected to the housing. The power cord may power the alarm and charges the device.

In an embodiment, the height of the post may be in a range from approximately twenty-four inches to approximately sixty inches.

In an embodiment, an access point on the housing to control the operation of the alarm requires keyed access.

In an embodiment, the alarm produces an alarm signal.

In an embodiment, a teach button may be connected to the housing. The teach button may control operation of the device.

In an embodiment, a second housing may be connected to the post. A second device may connect to the second housing.

In an embodiment, a sensor cable may be connected to the housing and further connected to a clamp wherein the clamp connects to the device.

In an embodiment, the post may have a bent portion located between an upper portion of the post and a lower portion of the post. The bent portion may offset the upper portion of the post relative to the lower portion of the post.

In an embodiment, the height of the post may be adjustable.

In yet another embodiment, a method for securing a portable electronic device on a stand in a room for use by a user is provided. The method has the step of attaching a post to a base wherein the post may have a top and a bottom defining a height of the post. The bottom of the post may be attached to the base. The base may be located on a floor in the room, A plate may be attached adjacent to the top of the post. The plate may have a substantially planar surface. The method also has the steps of tethering the portable electronic device to the plate; providing an alarm wherein the alarm is activated by disconnecting the portable electronic device from the plate; removably mounting the portable electronic device adjacent to the substantially planar surface of the plate wherein the portable electronic device is located in a position above the floor at a height approximately equal to the height of the post; and removing the portable electronic device from the plate for use by the user.

In an embodiment, the method has the step of selecting the post with the height of the post approximately equal to a height of the user when seated.

In an embodiment, the method has the step of connecting a second plate to the top of the post wherein the second plate is located in a position substantially opposite the plate.

In an embodiment, the method has the step of controlling the operation of the alarm using a keyed control on the plate.

In an embodiment, the method has the step of connecting a strength member between the plate and the portable electronic device wherein the strength member restricts removal of the portable electronic device.

In an embodiment, the method has the step of selecting a type of alarm signal produced by the alarm.

It is, therefore, an advantage of the present invention to provide a tablet stand apparatus and/or a system to allow users access to an electronic tablet for use.

An advantage of the present invention is to provide a tablet stand apparatus and/or a system that is portable.

Another advantage of the present invention is to provide a tablet stand apparatus, a method and/or a system that may provide multiple users with access to a tablet.

Yet another advantage of the present invention is to provide a tablet stand apparatus, a method and/or a system that may prevent theft of the tablet.

Still another advantage of the present invention is to provide a tablet stand apparatus, a method and/or a system that may allow periodic use of a tablet.

Another advantage of the present invention is to provide a tablet stand apparatus, a method and/or a system that may allow charging and/or recharging of the tablet.

Yet another advantage of the present invention is to provide a tablet stand apparatus and/or a system that may securely attach the tablet.

Another advantage of the present invention is to provide a tablet stand apparatus and/or a system that may hold multiple tablets.

Yet another advantage of the present invention is to provide a tablet stand apparatus, a method and/or a system that is simple to use.

Still another advantage of the present invention is to provide a tablet stand apparatus and/or a system that is inexpensive.

Another advantage of the present invention is to provide a tablet stand apparatus, a method and/or a system that may allow more than one user at a time.

Moreover, another advantage of the present invention is to provide a tablet stand apparatus and/or a system that may allow different types of tablets to be used.

Still another advantage of the present invention is to provide a tablet stand apparatus and/or a system that may be used in waiting areas.

Yet another advantage of the present invention is to provide a tablet stand apparatus and/or a system that may be used adjacent to a chair for ease of access to the tablet.

Moreover, another advantage of the present invention is to provide a tablet stand apparatus and/or a system that may be used between and/or adjacent to a pair of chairs for ease of access to multiple tablets for multiple users.

Further, an advantage of the present invention is to provide a tablet stand apparatus and/or a system that may be used in a variety of settings.

Additional features and/or advantages of the present invention described in, and/or will be apparent from, the detailed description of the presently preferred embodiments and/or from the drawings.

### BRIEF DESCRIPTION OF THE DRAWINGS

FIG. 1 is a front perspective view of an embodiment of a tablet stand apparatus and a system of the present invention.

FIG. 2 is an exploded front perspective view of an embodiment of a tablet stand apparatus and a system of the present invention with tablets attached thereto.

FIG. 3 is a side view of an embodiment of a tablet stand apparatus and a system of the present invention.

FIG. 4 is a rear perspective view of an embodiment of a tablet stand apparatus and a system of the present invention.

FIG. 5 is a perspective view of an embodiment of a tablet stand apparatus and a system of the present invention with a tablet attached thereto.

FIG. 6 is a front perspective view of another embodiment of a tablet stand apparatus of the present invention.

FIG. 7 is a cross-sectional view of an embodiment of a tablet stand apparatus of the present invention taken along line VII-VII of FIG. 6.

FIG. 8 is a front perspective view of an embodiment of a tablet stand apparatus and a system of the present invention with tablets attached thereto.

FIG. 9 is a perspective view of an embodiment of the present invention illustrating a connection of the tablet to the stand.

FIG. 10 is a side view of an embodiment of the present invention illustrating a connection of the tablet to the stand.

### DETAILED DESCRIPTION OF THE DRAWINGS

The present invention generally relates to a tablet stand. More specifically, the present invention relates to a portable tablet stand apparatus and/or a system to allow users access to an electronic tablet.

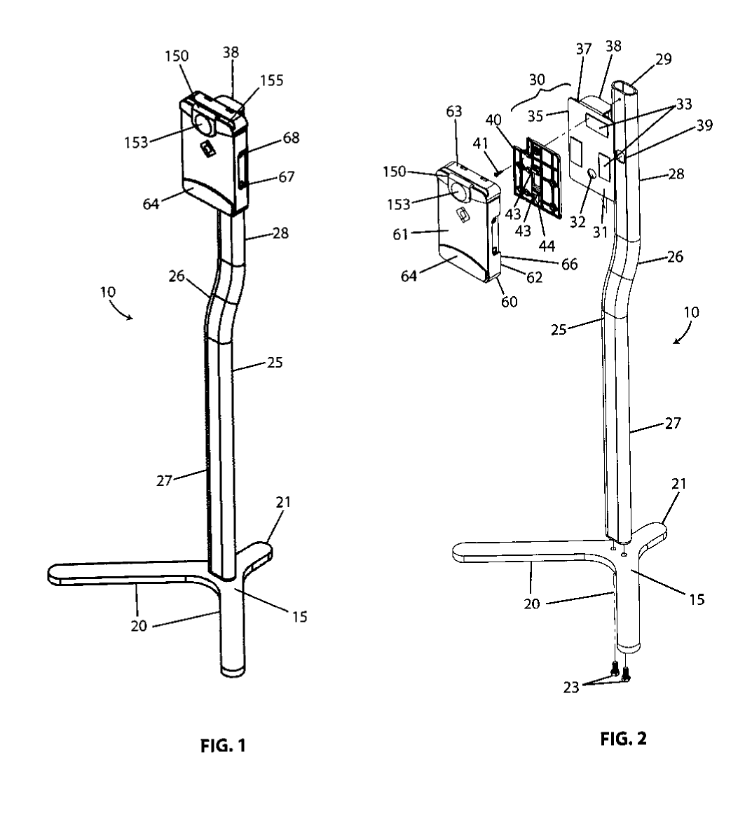

Referring now to the drawings, wherein like numerals refer to like parts, FIGS. 1-5 illustrate an embodiment of a single tablet stand apparatus 10. The single tablet stand apparatus 10 may be configured to hold one tablet 11. The tablet 11 may be, for example, an iPad® tablet (a registered trademark of Apple Inc.), a Kindle® tablet (a registered trademark of Amazon Technologies, Inc.), a Nook® tablet (a registered trademark of BarnesandNoble.com LLC), a Galaxy® tablet (a registered trademark of Samsung Electronics Co. Ltd), a Nexus® tablet (a registered trademark of Google, Inc.) and/or the like.

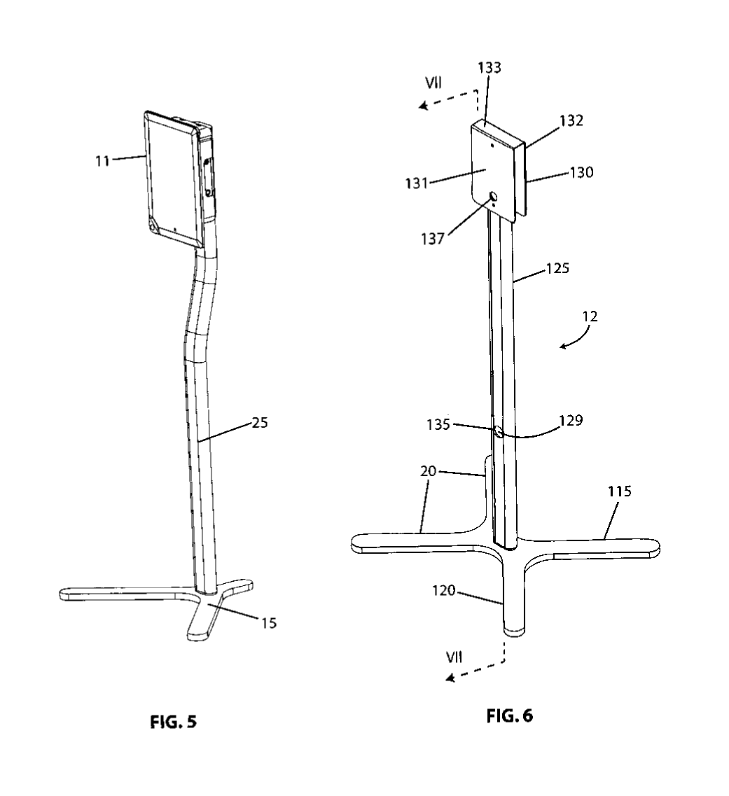

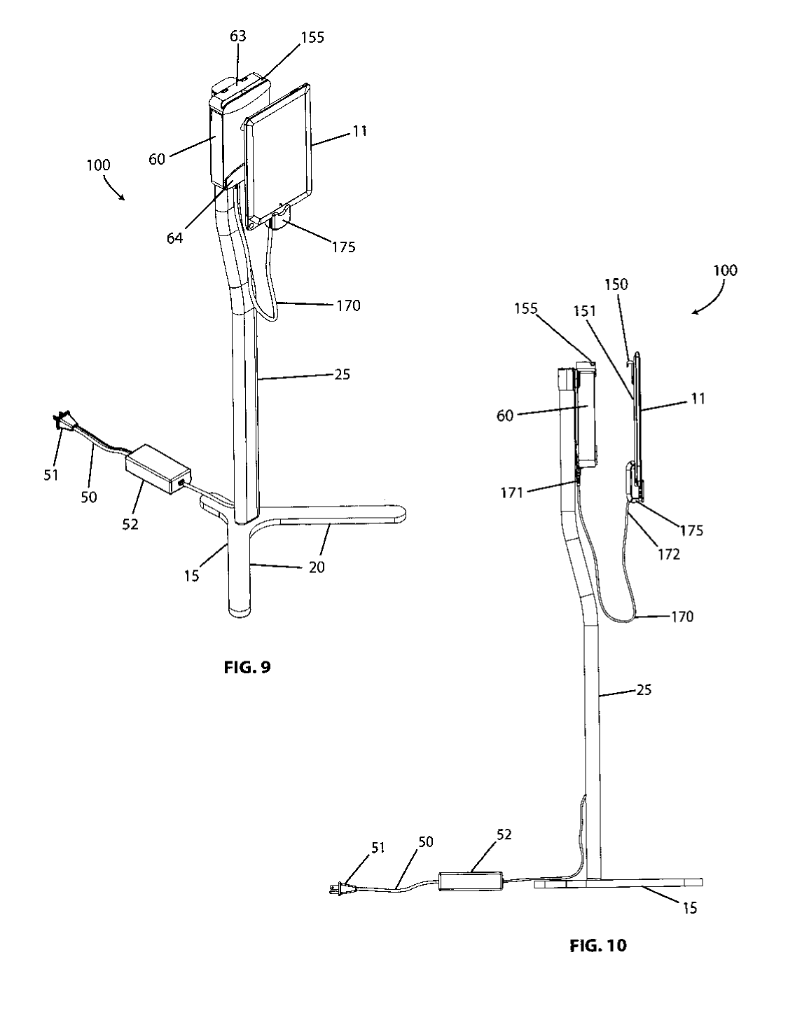

FIGS. 6-8 illustrate an embodiment of a dual tablet stand apparatus 12. The dual tablet stand apparatus 12 may be configured to hold two tablets 11. Two tablets 11 may be mounted to the dual tablet stand apparatus 12 in a substantially back-to-back arrangement. The single tablet stand apparatus 10 and/or the dual stand tablet apparatus 12 may be part of a system 100 as shown in FIGS. 9 and 10.

As illustrated in FIGS. 1-5, the single tablet stand apparatus 10 may have a base 15. The base 15 may have two front supports 20 and a back support 21. The two front supports 20 and/or the back support 21 may extend outwardly from the base 15. In an embodiment, the front supports 20 may be substantially equivalent in size and/or in shape. The front supports 20 may be located at approximately 120° from each other. The front supports 20 may also be located at approximately 120° from the back support 21. Thus, the front supports 20 and the back supports 21 may be located at approximately 120° from each other. Of course, the front supports 20 and/or the back support 21 may be located at other angles relative to each other, as desired.

The single tablet stand apparatus 10 may also have a post 25. The post 25 may be substantially vertical. The post 25 may be connected to the base 15 by fasteners 23. The fasteners 23 may be bolts, screws, rivets and/or the like. In an embodiment, the post 25 may also have a bent portion 26. The bent portion 26 may be located in a position between a lower portion 27 of the post 25 and an upper portion 28 of the post 25. In an embodiment, the post 25 may be hollow. Thus, the post 25 may have an interior 29.

As shown in FIG. 2, the single tablet stand apparatus may have a mounting plate assembly 30. The mounting plate assembly 30 may allow connection to a housing 60. The mounting plate assembly 30 may be connected to the upper portion 28 of the post 25. The mounting plate assembly 30 may have a sub-plate 31. The sub-plate 31 may be substantially rectangular. In an embodiment, the sub-plate 31 may be constructed from metal, for example.

The sub-plate 31 may have a hole 32 formed therein. The sub-plate 31 may also have an adhesive 33 affixed thereon. The sub-plate 31 may have a front surface 35 and a back surface 36. The hole 32 may extend through the sub-plate 31 from the front surface 35 to the back surface 36. The adhesive 33 may be affixed to the front surface 35 of the sub-plate 31.

The sub-plate 31 may have a top 37. A tab 38 may be located on the top 37 of the sub-plate 31. The tab 38 may extend beyond the back surface 36 of the sub-plate 31. The tab 37 may also be substantially perpendicular to the sub-plate 31. The upper portion 28 of the post 25 may have a hole 39. The sub-plate 31 may be connected to the upper portion 28 of the post 25. The hole 32 in the sub-plate 31 may align with the hole 39 on the upper portion 28 of the post 25. Further, the tab 37 on the sub-plate 31 may cover and/or may enclose the interior 29 of the upper portion 28 of the post 25.

The mounting plate assembly 30 may have a mounting plate 40. In an embodiment, the mounting plate 40 may be constructed of plastic. As illustrated in FIG. 2, the mounting plate 40 may have tabs 43. The tabs 43 may have an upward bend. The tabs 43 may allow the housing 60 to be secured to the mounting plate 40. For example, the upward bend in the tabs 43 may engage with the housing 60 to clamp the housing 60 to the mounting plate 40. The tabs 43 may be arranged adjacent to an opening 44 in the mounting plate 40. In an embodiment, the housing 60 may have a contact plunger (not shown). The contact plunger may pass through the opening 44 to contact the sub-plate 31. The contact plunger in the housing 60 and the sub-plate 31 may provide an electrical contact and/or a pressure contact.

The mounting plate 40 may be secured to the upper portion 28 of the post 25 by fasteners 41, such as, for example, screws, rivets and/or the like. The fasteners 41 may pass through the mounting plate 40 and/or the sub-plate 31. As a result, the fastener 41 may also secure the sub-plate 31 to the upper portion 28 of the post 25. Further, the adhesive 33 on the front surface 35 of the sub-plate 31 may adhere the mounting plate 40 to the sub-plate 31. The mounting plate 40 may be sized such that the mounting plate 40 may not cover, obstruct and/or interfere with the hole 32 in the sub-plate 31.

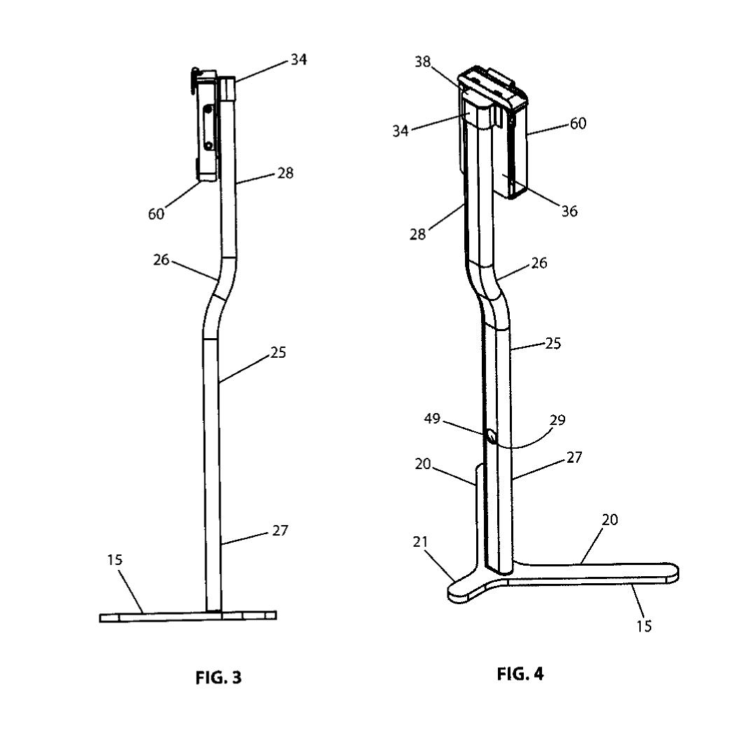

As shown in FIGS. 3 and 4, a strap 34 may further secure the sub-plate 31 to the post 25. The strap 34 may be secured to the upper portion 28 of the post 25 by fasteners 41, such as, for example, screws, rivets and/or the like. The strap 34 may follow the contour of the post 25.

As shown in FIG. 4, the lower portion 27 of the post 25 may have a hole 49. The hole 49 may provide access to the interior 29 of the post 25. In an embodiment, a power cord 50 may be inserted into the hole 49 in the lower portion 27 of the post 25 as shown in FIGS. 9 and 10. The power cord 50 may have a plug 51 and/or a power conditioner 52. For example, the power conditioner 52 may be a transformer, a surge protector, a voltage regulator and/or the like.

In an embodiment, the power cord 50 may pass through the interior 29 of the post 25 and/or may exit through the hole 39 in the upper portion 28 of the post 25. The power cord 50 may also pass through the hole 32 in the sub-plate 31. The power cord 50 may connect to the housing 60. Other cabling, such as, for example, control cabling, an alarm cable and/or the like may also be inserted into the hole 49 and/or may pass through the interior 29 of the post 25 and/or may exit through the hole 39 in the upper portion 28 of the post 25.

The housing 60 may have a front surface 61 and a top surface 63. The housing 60 may also have an interior 62. The housing 60 may have a pad 64 located on the front surface 61 as shown in FIGS. 1-3. The pad 64 may be constructed of rubber, silicone and/or the like, for example, to provide a protective and/or a cushioning surface for the tablet 11 in a mounted position as shown in FIG. 5.

The housing 60 may have control circuitry (not shown) located therein. The power cord 50 may connect to the control circuitry. An alarm 66 may also be located within the housing 60. The alarm 66 may be connected to the control circuitry. The alarm 66 may produce a visual and/or an audible alarm signal. The alarm 66 may produce the audible alarm by using a piezoelectric (piezo) audible alarm and/or a buzzer, for example.

In an embodiment, the type of alarm signal may be selected by a user of the system 100. For example, an audible alarm may be appropriate in certain situations and/or locations. In other situations, the alarm may be excessive and/or may be too disruptive. Therefore, the user may select to set the system 100 to produce only a visual alarm.

The user may select and/or may control the alarm 66 using a teach button 67 on the housing 60 as shown in FIGS. 1-3. The teach button 67 may allow the user to set the system 100 for the type of tablet 11 that may be used with the system 100. A key hole 68 may be used by an authorized user to control the alarm 66, as desired. The key hole 68 may require a specialized type of key to operate the alarm 66. The key hole 68 may also be used to deactivate an active alarm signal.

In an embodiment, the housing 60 may be constructed of a translucent and/or a clear material. The alarm 66 may produce the visual alarm signal using lights, LEDs and/or the like. The visual alarm signal may be constant, intermittent and/or flashing. The light generated by the visual alarm signal may illuminate the housing 60. Thus, the housing 60 may illuminate in a synchronized manner with the visual alarm signal.

FIGS. 6-8 illustrate the dual tablet stand apparatus 12. The dual tablet stand apparatus 12 may be configured to hold two tablets 11. As shown in FIG. 8, two tablets 11 may be mounted to the dual tablet stand apparatus 12 in a substantially back-to-back arrangement.

As shown in FIGS. 6-8, the dual tablet stand apparatus 12 may have a base 115. The base 115 may have supports 120. The supports 120 may extend outwardly from the base 115. In an embodiment, the supports 120 may be substantially equivalent in size and/or in shape. The supports 120 may be located approximately 90° from each other. Of course, the supports 120 may be located at other angles relative to each other, as desired.

The dual tablet stand apparatus 12 may also have a post 125 that may be substantially vertical. The post 125 may be connected to the base 115 by fasteners 123. The fasteners 123 may be bolts, screws, rivets and/or the like, for example. The fasteners 123 may extend through the base 115 and/or may connect to a bottom 124 of the post 125. In an embodiment, the post 125 may be hollow. Thus, the post 125 may have an interior 129.

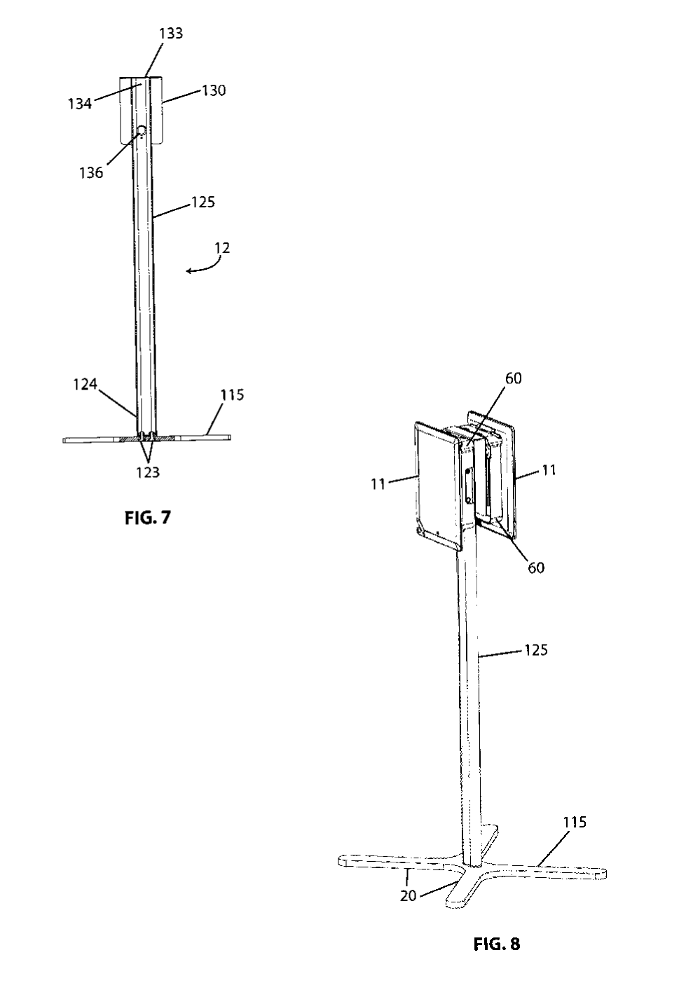

As shown in FIGS. 6 and 7, the dual tablet stand apparatus 12 may have a dual mounting plate 130. The dual mounting plate 130 may be connected to the post 125. The dual mounting plate 130 may have a first mounting surface 131 and/or a second mounting surface 132. The first mounting surface 131 and/or the second mounting surface 132 may be substantially rectangular. The dual mounting plate 130 may have a top surface 133. The top surface 133 may be perpendicular to the first mounting surface 131 and/or the second mounting surface 132. The top surface 133 may be positioned at a top 134 of the post 125.

As shown in FIG. 6, the post 125 may have a hole 135 formed near and/or adjacent to the bottom 124 of the post 125. The hole 135 may provide access to the interior 129 of the post 125.

As shown in FIG. 7, the post 125 may also have a hole 136 formed near and/or adjacent to the top 134 of the post 125. The hole 136 may provide access to the interior 129 of the post 125. The hole 136 may extend through the post 125.

The dual mounting plate 130 may be connected to the top 134 of the post 125. The first mounting surface 131 and the second mounting surface 132 may each have a hole 137 formed therein. The hole 137 in each of the first mounting surface 131 and/or the second mounting surface 132 may align with the hole 136 near and/or adjacent to the top 134 of the post 125. Further, the top surface 133 of the dual mounting plate 130 may cover and/or may enclose the interior 129 of the post 125 at the top 134 of the post 125.

The dual mounting plate 130 may be secured to the top 134 of the post 125 by fasteners 41, such as, for example, bolts, screws, rivets and/or the like. The fasteners 41 may extend through the first mounting surface 131 and/or the second mounting surface 132. As a result, the fasteners 41 may also secure the dual mounting plate 130 to the post 125.

In an embodiment, the power cord 50 may be inserted into the hole 135 near the bottom 124 of the post 125. The power cord 50 may pass through the interior 129 of the post 125 and/or may exit through the hole 136 near the top 134 of the post 125. The power cord 50 may also pass through holes 137 in the first mounting surface 131 and/or the second mounting surface 132 of the dual mounting plate 130.

Referring to FIGS. 9 and 10, the single tablet stand apparatus 10 may be part of the system 100. As shown, the single tablet stand apparatus 10 may have the power cord 50 inserted into the hole 49 in the post 25. The tablet 11 may have a hook 150. The hook 150 may be attached to a back side 151 of the tablet 11. As shown in FIGS. 1 and 2, the hook 150 may have an adhesive 153. In an embodiment, the adhesive may secure the hook 150 to the tablet 11.

The housing 60 may have a slot 155 that may be located at the top 63 of the housing 60. The slot 155 may be configured and/or be sized to receive the hook 150 attached to the tablet 11. The hook 150 may allow the tablet 11 to be mounted to and/or removed from the housing 60 of the single tablet stand apparatus 10, as desired. The slot 155 may slope downwardly toward the center of the housing 60 to guide the hook 150 to the center of the slot 155. As shown in FIG. 5, the tablet 11 may be substantially vertical in a mounted position on the single tablet stand apparatus 10. The tablet 11 may be substantially adjacent to the housing 60.

As shown in FIGS. 9 and 10, the tablet 11 may be tethered to the housing 60. For example, a sensor cable 170 may be connected to the housing 60. A first end 171 of the sensor cable 170 may connect to the housing 60, and a second end 172 of the sensor cable 170 may connect to a clamp sensor 175. The clamp sensor 175 may be secured to the tablet 11. The clamp sensor 175 may may be connected to the alarm 66 by the sensor cable 170.

The sensor cable may have a length extending from the housing 60 to the clamp sensor 175. In an embodiment, the length of the sensor cable 175 may allow the user freedom of movement and/or ease of access to the tablet 11. Also, the length of the sensor cable 175 may prevent the tablet 11 from contacting the floor. For example, in the event the user drops the tablet 11 and/or the tablet 11 may become disconnected from the housing 60, the length of the sensor cable 175 may be sized such that when the sensor cable 175 extends toward the base 15, the tablet 11 may remain above the floor.

The sensor cable 170 may have a charging cable 177 (not shown). The charging cable 177 may be within the sensor cable 170. The charging cable 177 may supply power to the tablet 11 and may plug into a power jack of the tablet 11 for charging and/or for recharging the tablet 11. The charging cable 177 may have a corresponding plug to mate to the power jack on the tablet 11. Different proprietary plug types may be provided, as needed.

Thus, power may be supplied to the single tablet stand apparatus 10 for supplying power to the housing 60, the alarm 66 and/or the tablet 11. The power cord 50 may pass through the interior 29 of the post 25 and/or may connect to the housing 60. The charging cable 177 may connect to the tablet 11 for charging and/or for recharging the tablet 11.

In an embodiment, a strength member (not shown) may also be provided within the sensor cable 170. The strength member may be an aircraft cable, for example. The strength member may be flexible to allow ease of use of the tablet 11 by the users. However, the strength member may prevent cutting the the sensor cable 170 to prevent theft of the tablet 11.

In an embodiment, various situations and/or conditions may activate the alarm 66. For example, the alarm 66 may be activated upon disconnection and/or severing of the sensor cable 170. Removal of the clamp sensor 175 may also activate the alarm 66. Further, the contact plunger may activate the alarm 66. For example, an attempt to separate the housing 60 from the single tablet stand apparatus 10 may cause the contact plunger to lose contact with the sub-plate 31. The separation of the sub-plate 31 and the contact plunger may cause the electrical and/or the pressure contact to be broken which may trigger the alarm 66.

In use, the system 100 may be used by patients and/or customers in a waiting area. The single tablet stand apparatus 10 may be located next to a chair in the waiting room. The offset position of the upper portion 28 of the post 25 relative to the lower portion 27 of the post 25 may allow the base 15 to be placed closer to the chair to conserve floor space in a small waiting room, for example.

In an embodiment, the post 25 of the single tablet stand apparatus 10 may have a height corresponding to the height of the chair and/or the user when seated in the chair. The post may therefore be provided in a number of different heights. For example, the height of the post 25 may range from approximately two feet to approximately five feet. An embodiment may be provided for each type of seating height.

The user may be seated in a chair. The chair may be at a desk and/or a table. Typically, a chair may have a seat height of approximately 18 inches. Such a chair may be appropriate for the user to sit at the desk and/or at the table that has a typical height of approximately twenty-eight inches to approximately thirty inches. Thus, in an embodiment, the post 25 of the single tablet stand apparatus 10 may have a corresponding height in a range of approximately twenty inches to approximately thirty-four inches, for example.

Also, the single tablet stand apparatus 10 may be sized for use by small children, for example. Of course, the chair height and/or the table height for children may be smaller than the adult versions. Thus, the post 25 of the single tablet stand apparatus 10 may have a height corresponding to the height of the child-sized chair and/or table. Also, the height of the post 25 may correspond to a height of a standing child. Thus, in an embodiment of the single tablet stand apparatus 10 sized for children, the post 25 may have a corresponding height in a range of approximately eighteen inches to approximately thirty inches, for example.

In other embodiments, the post 25 of the single tablet stand apparatus 10 may have a height corresponding to other heights depending on the position of the user. For example, the user may be seated at a height greater than a standard chair height. For example, the user may be seated on a bar stool.

The user may be seated in a chair and/or on a stool at a counter. Typically, the counter has a height of approximately 36 inches. A stool with a seat height of approximately twenty-four inches to approximately twenty-six inches may be required to sit comfortably sit at the counter. Thus, in another embodiment, the post 25 of the single tablet stand apparatus 10 may have a corresponding height in a range of approximately thirty-one inches to approximately forty inches, for example.

Further, the user may be seated in a chair and/or on a stool at a bar. Typically, the bar has a height of approximately forty inches to approximately forty-two inches. A stool with a seat height of approximately 28 inches to approximately thirty inches may be required to sit comfortably sit at the bar. Thus, in a further embodiment, the post 25 of the single tablet stand apparatus 10 may have a corresponding height in a range of approximately thirty-six inches to approximately forty-six inches, for example.

Moreover, the user may be seated in a chair and/or on a stool at a spectator bar. Typically, the spectator height bar has a height of approximately forty-five inches to approximately forty-eight inches. A stool with a seat height of approximately thirty-three inches to approximately thirty-four inches may be required to sit comfortably sit at the spectator bar. Thus, in yet another embodiment, the post 25 of the single tablet stand apparatus 10 may have a corresponding height in a range of approximately forty-one inches to approximately fifty-two inches, for example.

In still another another embodiment, the single tablet stand apparatus 10 may be used by a standing user. Thus, the post 25 of the single tablet stand apparatus 10 may have a height in a range of approximately forty inches to approximately sixty inches, for example. Of course, the height of the post 25 may correspond to the position of the user so that the tablet 11 may be conveniently and/or easily accessible to provide comfortable and/or efficient use. Thus, the post 25 may be any height that may be ergonomically appropriate relative to the height of the seated and/or standing user.

In an embodiment, the height of the post 25 may be adjustable. The height adjustment may provide versatility and/or may enable the single tablet stand apparatus 10 to be used with various user situations. For example, the single tablet stand apparatus 10 may be used in a room having chairs and bar stools. The height of the post may be adjusted to accommodate the different user positions.

Further, the dual tablet stand apparatus 12 may be placed between two chairs in the waiting room. The chairs may be closely arranged and may abut the post 125. The back-to-back arrangement of the dual mounting plate 130 may allow users in each of the two chairs to access the two tablets 11 simultaneously. The tablets 11 may be continuously connected to the power cord 50 to remain charged and/or ready for use. Typically, the user may begin using the tablet 11 by pressing a power button on the tablet 11 to awake the tablet 11 from a possible resting state.

Of course, the height of the post 125 of the dual tablet stand apparatus 12 may correspond to the position of the user so that the tablet 11 may be conveniently and/or easily accessible for comfortable and/or efficient use. Thus, the post 125 may be any height that may be ergonomically appropriate relative to the height of the seated and/or standing user.

Also, the system 100 may provide theft prevention of the tablet 11. For example, in the event that a user may attempt to remove the tablet 11 from the single tablet stand apparatus 10 and/or from the dual tablet stand apparatus 12, the alarm 66 may provide the alarm signal. The alarm signal may alert the owner of an attempted theft. The strength member may also prevent and/or inhibit the theft of the tablet 11.

It should be understood that various changes and/or modifications to the presently preferred embodiments described herein will be apparent to those skilled in the art. Such changes and/or modifications may be made without departing from the spirit and/or the scope of the disclosure and without diminishing its attendant advantages. It is, therefore, intended that such changes and modifications be covered by the appended claims.

We claim:

1. A system for electrically connecting and securing a device to a stand, the system comprising:
a base;
a post having top and a bottom defining a height of the post wherein the bottom of the post connects to the base wherein the post extends in a substantially vertical direction from the base and further wherein the height of the post is at least twenty inches;
a housing connected adjacent to the top of the post wherein the device connects to the housing;
an alarm associated with the housing wherein the alarm is activated by disconnecting the device from the housing; and
a power cord connected to the housing wherein the power cord powers the alarm and charges the device.

2. The system of claim 1 wherein the height of the post is in a range from approximately twenty-four inches to approximately sixty inches.

3. The system of claim 1 further comprising:
an access point on the housing to control the operation of the alarm wherein the access point requires keyed access.

4. The system of claim 1 wherein the alarm produces an alarm signal.

5. The system of claim 1 further comprising:
a teach button connected to the housing wherein the teach button controls operation of the device.

6. The system of claim 1 further comprising:
a second housing connected to the post wherein a second device connects to the second housing.

7. The system of claim 1 further comprising:
a sensor cable connected to the housing and further connected to a clamp wherein the clamp connects to the device.

8. The system of claim 1 wherein the post has a bent portion located between an upper portion of the post and a lower portion of the post wherein the bent portion offsets the upper portion of the post relative to the lower portion of the post.

9. The system of claim 1 wherein the height of the post is adjustable.

10. A method for securing a portable electronic device on a stand in a room for use by a user, the method comprising the steps of:
attaching a post to a base wherein the post has a top and a bottom defining a height of the post wherein the bottom of the post is attached to the base wherein the base is located on a floor in the room and further wherein a plate is attached adjacent to the top of the post wherein the plate has a substantially planar surface;
tethering the portable electronic device to the plate;
providing an alarm wherein the alarm is activated by disconnecting the portable electronic device from the plate;
removably mounting the portable electronic device adjacent to the substantially planar surface of the plate wherein the portable electronic device is located in a position above the floor at a height approximately equal to the height of the post; and
removing the portable electronic device from the plate for use by the user.

11. The method of claim 10 further comprising the step of:
selecting the post with the height of the post approximately equal to a height of the user when seated.

12. The method of claim 10 further comprising the step of:
connecting a second plate to the top of the post wherein the second plate is located in a position substantially opposite the plate.

13. The method of claim 10 further comprising the step of:
controlling the operation of the alarm using a keyed control on the plate.

14. The method of claim 10 further comprising the step of:
connecting a strength member between the plate and the portable electronic device wherein the strength member restricts removal of the portable electronic device.

15. The method of claim 10 further comprising the step of:
selecting a type of alarm signal produced by the alarm.

16. An apparatus comprising:
a base;
a post extending from a first end to a second end defining a height of the post wherein the first end of the post is attached to the base wherein the height of the post is at least twenty-four inches;
a housing connected to the second end of the post wherein the housing has a slot configured to receive an electronic device to connect the electronic device to the housing; and
a sensor cable connected to the electronic device and further connected to the housing wherein an alarm is activated upon disconnection of the sensor cable.

17. The apparatus of claim 16 wherein the housing is translucent.

18. The apparatus of claim 16 further comprising:
a mounting plate connected to a sub-plate wherein the sub-plate is connected to the post and further wherein the mounting plate is located in a position between the sub-plate and the housing.

19. The apparatus of claim 16 further comprising:
a power cord extending through an interior of the post.

20. The apparatus of claim 16 further comprising:
a hook attached to the electronic device wherein the hook engages the slot in the housing to connect the electronic device to the housing.
